(19) United States
(12) Patent Application Publication
(10) Pub. No.: US 2006/0187562 A1
(43) Pub. Date: Aug. 24, 2006

(54) Optical zoom system

(75) Inventors: Steve S. Mounnarat, Fairport, NY (US); Edwin A. Hazard, Rochester, NY (US)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES-OPTEM INC.

(21) Appl. No.: 11/335,816

(22) Filed: Jan. 20, 2006

Related U.S. Application Data
(60) Provisional application No. 60/645,006, filed on Jan. 21, 2005.

(51) Int. Cl. G02B 7/02

(52) U.S. Cl. 359/824

(57) ABSTRACT

A zoom system for positioning a lens carriage and corresponding method are described. The zoom system includes a drive motor, a lens carriage, and a control system. The drive motor moves the lens carriage including a read head for generating a signal indicative of the lens carriage position. The control system generates a signal causing the drive motor to move the lens carriage and generates a signal causing the drive motor to either stop or move the lens carriage based on the read head generated signal. The method includes generating a first control signal causing a drive motor to move a lens carriage to a predetermined position responsive to a magnification change signal; generating by the lens carriage a read head signal based on detection of an indicator on a tape scale; and generating a second control signal causing the drive motor to stop moving the lens carriage at the predetermined position responsive to the first read head signal.

### CROSS-REFERENCE TO RELATED APPLICATION

The present Application is based on U.S. Provisional Application No. 60/645,006, filed on Jan. 21, 2005, and priority is hereby claimed under 35 USC §119 based on this application, which is hereby incorporated by reference in its entirety into the present application.

### FIELD

The disclosed embodiments relate to an optical zoom system.

### BACKGROUND

To provide zooming capability to an optical system, the zoom module must be capable of displacing a series of lens elements along an optical axis. In order to achieve an optimum image with the proper magnification, the displaced elements must exhibit several key metrics. Each lens element must be located in strict relationship with each other. Each lens element must also move and return to its respective positions repeatedly and consistently.

FIG. 1a depicts a cam-driven optical zoom system 100 including a first tube 102 (also referred to as an inner tube) having a first fixed lens element 104 positioned in one tube opening and a second fixed lens element 106 positioned at the opposite tube opening. First tube 102 includes a linear longitudinal slot 108 extending lengthwise along axis A of the tube and providing an opening from the interior to the exterior of the tube.

Tube 102 includes a first movable lens element 110 and a second movable lens element 112 positioned interior of the tube. First and second movable lens elements 110, 112 slide along axis A within the interior of tube 102 to predetermined positions in order to achieve a particular magnification level. That is, the movable elements 110, 112 are positioned such that an image viewed through tube 102 via fixed and movable lens elements 104, 106, 110, 112 is magnified by a particular amount based on the relative position of the lens elements.

In order to control the position of first and second movable lens elements 110, 112 within tube 102, a second tube 114 (also referred to as an outer tube) axially surrounds the first tube. That is, the openings of outer tube 114 and inner tube 102 are coaxially aligned along axis A. Outer tube 114 includes a helical slot 116 extending in a spiral along axis A and providing an opening from the interior to the exterior of the tube. Helical slot 116 intersects linear slot 108 at one or more locations along the length of system 100 providing an opening from the interior to the exterior of the system.

First movable lens element 110 includes a positioning pin 118 extending radially from the lens element and positioned within helical slot 116 and linear slot 108. Second movable lens element 112 includes a positioning pin (not shown) extending radially from the lens element and positioned with helical slot 116 and linear slot 108. As the inner tube 102 and outer tube 114 rotate axially with respect to each other, the intersection of helical slot 116 and linear slot 108 urges positioning pin 118 along axis A. Depending on the direction with which tubes 102, 114 are rotated with respect to each other, positioning pin 118 moves one or another direction along axis A. Due to the connection of positioning pin 118 with first movable lens element 110, movement of the pin causes movement of the lens element.

Second movable lens element 112 operates in a similar manner to first movable lens element 110. In this manner, the rotation of one or both of inner tube 102 and outer tube 114 positions first and second movable lens elements 110, 112 within the inner tube along axis A.

FIG. 1b depicts an exploded parts view of the FIG. 1a system 100 components including movable lens elements 110, 112, inner tube 102, and outer tube 114.

FIG. 2 depicts a chart of the displacement relationship between first and second movable lens elements 110, 112 in order to achieve different levels of magnification with respect to an image viewed through the system 100. A position axis relates the position of movable lens elements 110, 112 with respect to each other at different magnification levels. As depicted, in order to achieve proper magnification, first and second movable lens elements 110, 112 each move along a non-linear relationship path. A complicated and sensitive helix manufacturing process known as “cam cutting” controls the relationship between the lens elements 110, 112 motion. Surface finish, slot to positioning pin fit, and inner tube 102 to movable lens element diameter fit all contribute to the performance of system 100. A complex and laborious process of mixing and matching and hand fitting is performed in order to obtain the proper fit and feel for a system 100. Current production processes for helical slot manufacturing have been exceeded by requirements on speed, life, and precision and repeatability for system 100.

### SUMMARY

The present embodiments provide an optical zoom system.

A system embodiment for positioning a movable lens carriage includes a drive motor, a movable lens carriage operatively connected with the drive motor, a control system operatively connected with the movable lens carriage and the drive motor. The movable lens carriage is movable by the drive motor and includes a read head for generating a signal indicative of a position of the movable lens carriage. The control system receives the read head generated signal and generates a signal to cause the drive motor to move the movable lens carriage and generates a signal to cause the drive motor to perform at least one of: (a) stop moving the movable lens carriage based on the received read head generated signal and (b) move the movable lens carriage based on the received read head generated signal.

Another system embodiment of an optical zoom system for positioning movable lens carriages includes a linear extending rail, a first movable lens carriage and a second movable lens carriage coupled with and movable along a portion of the rail, a first drive motor and a second drive motor coupled with, respectively, the first and second movable lens carriages, and a control system. The first and second movable lens carriages include, respectively, a first and second read head positioned to detect and generate a first and second read head signal indicating motion of the first movable lens carriage along a portion of the rail. The first drive motor and second drive motors are coupled with the first and second movable lens carriages and arranged to move the movable lens carriages along a portion of the rail responsive to a first and second control signal, respectively. The control system is connected with the first and second movable lens carriages and the first and second drive motors and is arranged to generate at least one of a first control signal and a second control signal responsive to receipt of a magnification change signal.

A method embodiment of modifying a magnification level of an image provided by an optical zoom system includes generating, by a control system, a first control signal to cause a first drive motor to move a first movable lens carriage to a predetermined position responsive to receipt of a magnification change signal; generating by the first movable lens carriage a first read head signal based on detection by a first read head of an indicator on a tape scale adjacent the first read head; and generating, by the control system, a second control signal to cause the first drive motor to stop moving the first movable lens carriage at the predetermined position responsive to receipt of the first read head signal.

Another method embodiment of positioning a movable lens carriage of an optical zoom system includes generating a control signal to move a movable lens carriage based on a first position of the movable lens carriage and a destination position of the movable lens carriage; and generating a modified version of the control signal based on a detected position of the movable lens carriage and the destination position.

Still other advantages of the embodiments will become readily apparent to those skilled in the art from the following detailed description, wherein the preferred embodiments are shown and described, simply by way of illustration of the best mode contemplated of carrying out the invention. As will be realized, the invention is capable of other and different embodiments, and its several details are capable of modifications in various obvious respects, all without departing from the embodiments.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1a is a perspective view diagram of a mechanical zoom system;

FIG. 1b is an exploded parts view of the FIG. 1a system;

FIG. 2 is a chart of a relationship between movable lens elements of the FIG. 1 zoom system;

FIG. 3 is a perspective view diagram of an optical zoom system according to an embodiment;

FIG. 4 is a perspective view diagram of the optical zoom system of FIG. 3 with the housing removed;

FIG. 5 is a high level block diagram of a control system according to an embodiment;

FIG. 6 is another perspective view diagram of the optical zoom system of FIG. 3 with housing removed;

FIG. 7 is a process flow diagram of a calibration process usable in conjunction with an embodiment;

FIG. 8 is a process flow diagram of a move process usable in conjunction with an embodiment;

FIG. 9 is another perspective view diagram of the optical zoom system of FIG. 3 with housing removed;

FIG. 10 is a detailed perspective view of drive motor and pulley system portion of system 300 according to an embodiment;

FIG. 11 is another detailed perspective view of the FIG. 10 embodiment;

FIG. 12 is a high level block diagram of a network usable in conjunction with an embodiment;

FIG. 13 is a perspective view diagram of a zoom system according to another embodiment with the housing removed;

FIG. 14 is another perspective view diagram of the zoom system of FIG. 13 with the housing removed;

FIG. 15 is a diagrammatic representation of lens positions according to an embodiment;

FIG. 16 is a perspective view diagram of a zoom system according to another embodiment with the housing removed;

FIG. 17 is another perspective view diagram of a zoom system according to another embodiment; and

FIG. 18 is a perspective view diagram of another embodiment of the optical zoom system of FIG. 3.

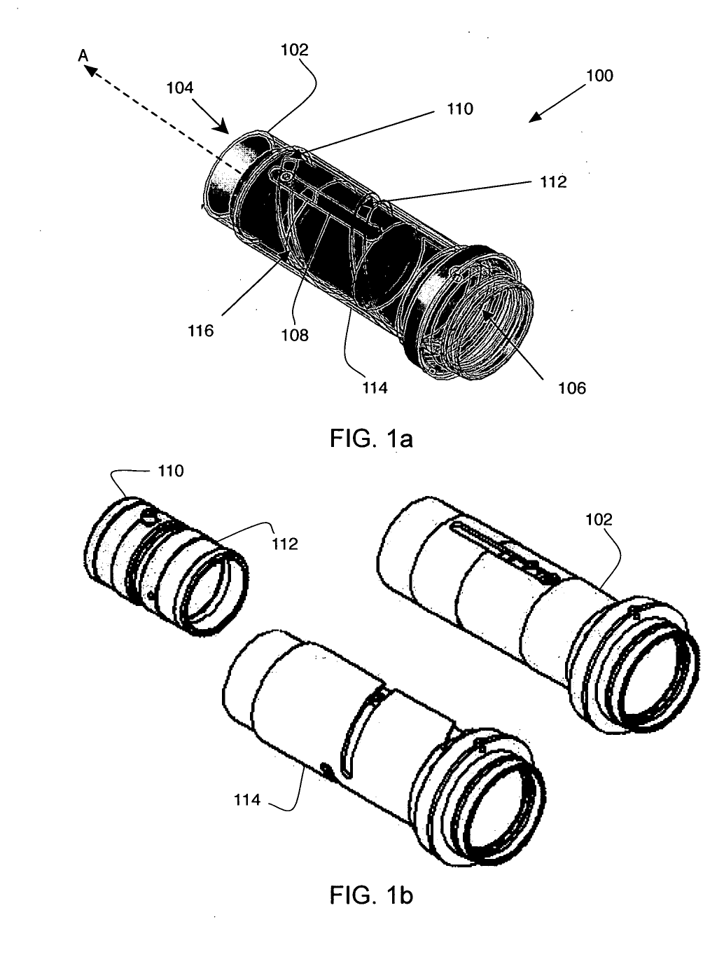

### DETAILED DESCRIPTION

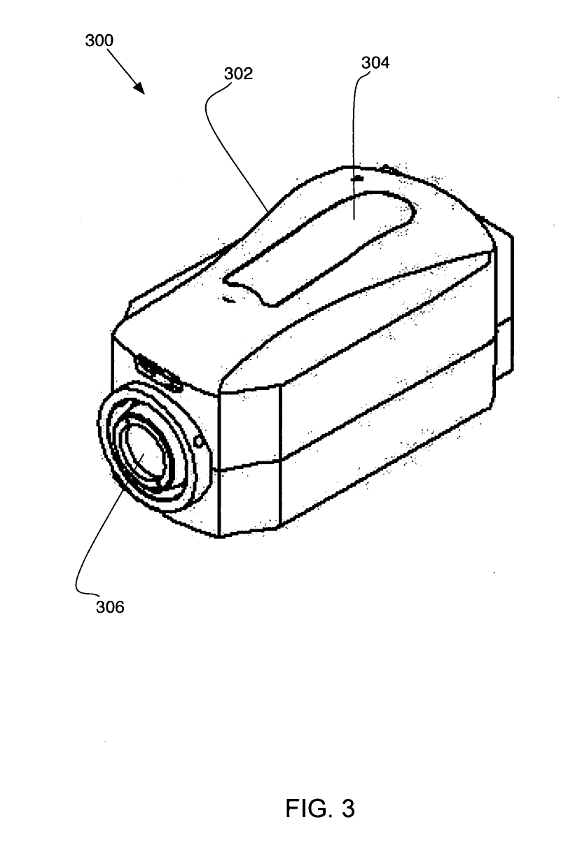

FIG. 3 depicts an optical zoom system 300 according to an embodiment. Optical zoom system 300 includes a housing 302 surrounding additional optical, electronic, and mechanical components described in detail below. As depicted in FIG. 3, housing 302 includes openings for a control panel 304 for controlling the magnification level provided by the system and a first fixed lens element 306 for receiving light forming an image for magnification.

Control panel 304 enables a user to control the motion and position of movable lens elements internal to zoom system 300 and thereby modify the magnification level provided by the zoom system. In some embodiments, control panel 304 is a touch sensitive, e.g., a capacitance-based, panel. In other embodiments, control panel 304 includes discrete buttons or switches or other signal-generating mechanisms to provide the below-described control signals to zoom system 300.

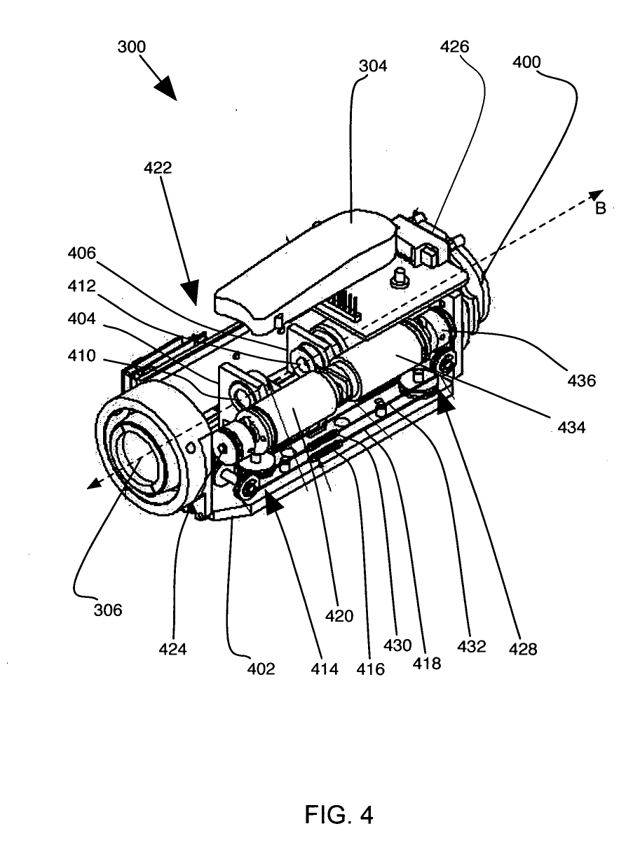

FIG. 4 depicts optical zoom system 300 without housing 302. According to some embodiments, zoom system 300 includes control panel 304, first fixed lens element 306 (also referred to as the fixed front lens element), and a second fixed lens element 400 (also referred to as the fixed rear lens element) at an end of the system opposite the fixed front lens element. Fixed front and rear lens elements 306, 400 are mounted in a fixed manner to opposite ends of a frame 402 forming the bottom of system 300.

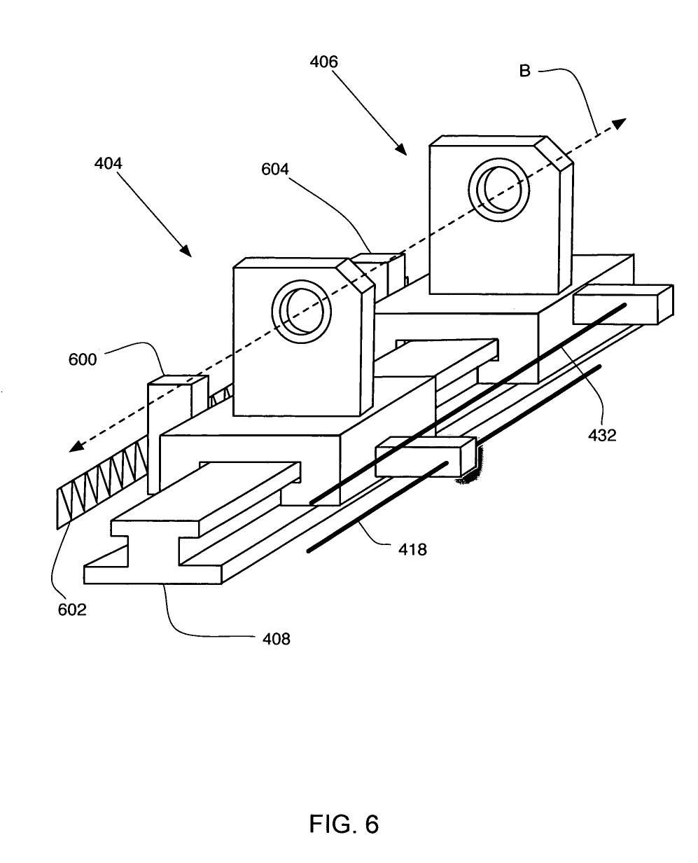

Zoom system 300 further includes a first movable lens carriage 404 and a second movable lens carriage 406 positioned between fixed front and rear lens elements 306, 400 and aligned along an axis B passing through the center point of the fixed lens elements. First and second movable lens carriages 404, 406 attach to a rail 408 mounted on frame 402. Lens carriages 404, 406 are independently movably mounted on rail 408 (depicted in FIG. 6), e.g., using a recirculating ball bearing mechanism, and are able to move between fixed first front and rear lens elements 306, 400 along the rail and along axis B. First and second movable lens carriages 404, 406 include corresponding first and second lenses 410, 412 mounted thereon and axially aligned to each other and lenses on fixed front and rear lens elements 306, 400.

System 300 includes first and second pulley systems 414, 428 connecting first and second drive motors 420, 434 with first and second movable lens carriages 404, 406.

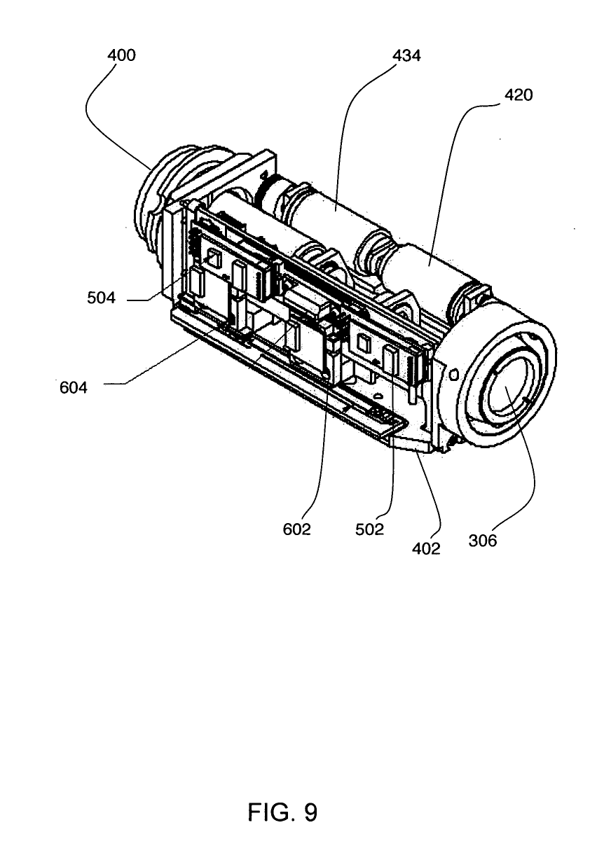

FIG. 9 is another perspective view of zoom system 300 without housing 302 and depicting additional components (described in detail below) of the zoom system including first and second encoders 502, 504 and first and second read heads 602, 604.

FIG. 6 is a detailed view of a portion of system 300 and depicts first movable lens carriage 404 attached to a first pulley system 414 by pulley line 418 in order to move along rail 408. As pulley system 414 moves pulley line 418, first movable lens carriage 404 moves along rail 408. FIG. 6 also depicts a first read head 600 connected with first movable lens carriage 404 and positioned to read a tape scale 602 alongside rail 408. In some embodiments, tape scale 602 is a metal tape scale having scribes or etchings which first read head 600 detects and translates into electrical signals which, in turn, the read head transmits to control system 422. In some embodiments, the pitch of each individual scribe or etching on tape scale 602 in conjunction with control system 422 determines the positioning resolution of zoom system 300. A second read head 604 is connected with second movable lens carriage 406 and positioned to read tape scale 602.

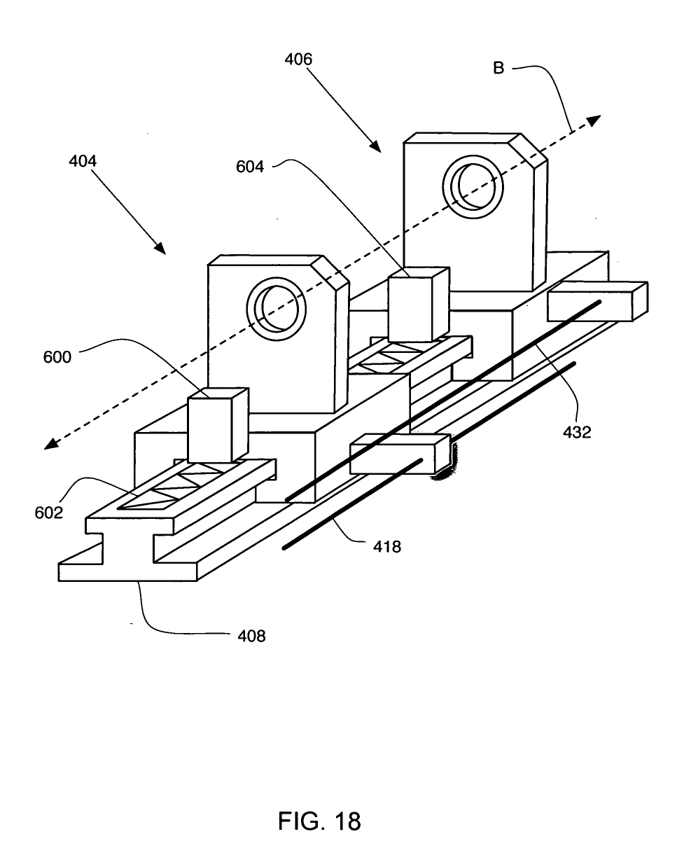

In some embodiments, tape scale 602 may be positioned other than alongside rail 408, e.g., along frame 402 and toward the bottom of carriage 404, above carriage 404, etc. In a further non-limiting embodiment depicted in FIG. 18, tape scale 602 is positioned along rail 408 and read heads 600, 604 are positioned and connected with carriage 404 to detect markings on the tape scale. Tape scale 602 may be applied to rail 408 and, in some embodiments, tape scale 602 may be formed as part of, or marked directly on, rail 408.

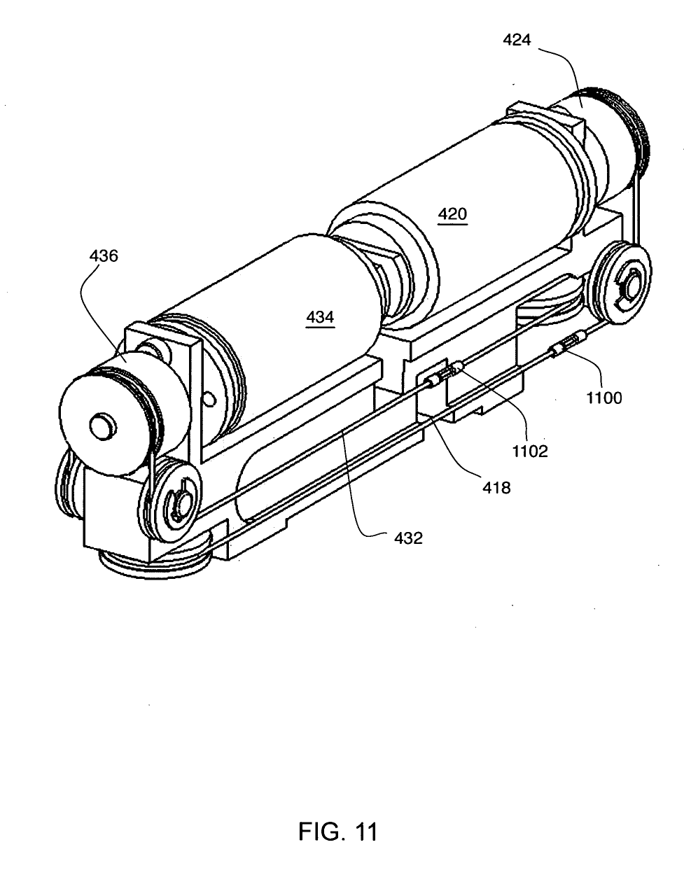

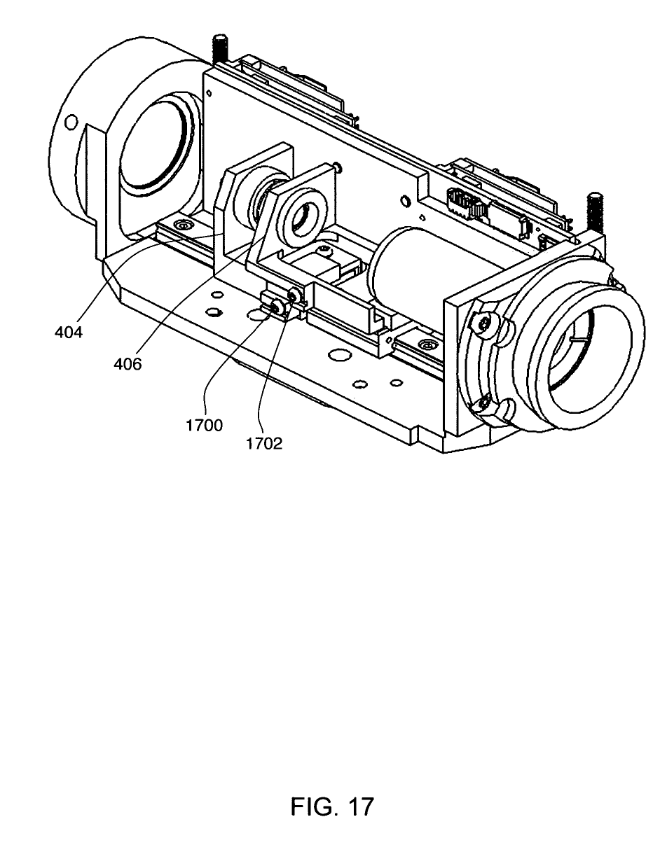

FIG. 17 depicts another view of the FIG. 4 zoom system embodiment with portions hidden to enable viewing of other portions of the zoom system. Specifically, FIG. 17 depicts a first screw 1700 connected with first movable lens carriage 404 and a second screw 1702 connected with second movable lens carriage 406. First screw 1700, e.g., a button head cap screw, connects first movable lens carriage 404 with first pulley line 418 by compressing lure 1100 (FIG. 11). Similarly, second screw 1702 connects second movable lens carriage 406 with second pulley line 432 by compressing lure 1102 (FIG. 11). In other embodiments, different mechanisms may be used to connect the movable lens carriage with the pulley line without departing from the scope and spirit of the embodiments.

In some embodiments, first pulley system 414 includes a tension spring 416 assisting in providing constant tension to the pulley system. That is, tension spring 416 accounts for expansion of pulley line 418 due to force during acceleration to move first movable lens carriage 404 and wear and/or expansion of the line over time. First movable lens carriage 404 attaches to pulley line 418 and moves axially as the pulley line traverses pulley system 414.

Pulley system 414 connects with a first drive motor 420 controlled by a control system (generally identified by reference numeral 422) described in detail below. First drive motor 420 connects with pulley system 414 and drives the pulley system to rotate thereby causing pulley line 418 to traverse the pulley system and move the attached first movable lens carriage 404. In some embodiments, first drive motor 420 includes a gearbox 424, e.g., an anti-backlash gearbox, for connecting with pulley system 414. In some embodiments, drive motor 420 may be one of an alternating current (AC) based and a direct current (DC) based motor.

Similar to first movable lens carriage 404, second movable lens carriage 406 attaches to a second pulley system 428 in order to move along rail 408 as depicted and described with respect to FIG. 6 above. In some embodiments, gearbox 436 connects second drive motor 434 with second pulley system 428. Second pulley system 428 includes a second read head 604 similar to first read head 600 for reading tape 602 and transmitting signals to control system 422.

In some embodiments, second pulley system 428 includes a tension spring 430 assisting in providing constant tension to the pulley system. As described above, tension spring 430 accounts for expansion of pulley line 432 due to force during acceleration to move second movable lens carriage 406 and wear and/or expansion of the line over time. Second movable lens carriage 406 attaches to pulley line 432 and moves axially as the pulley line traverses second pulley system 428.

Second pulley system 428 connects with a second drive motor 434 controlled by control system 422 which drives pulley system to rotate and thereby cause pulley line 432 to traverse the pulley system and move the attached second movable lens carriage 406. In some embodiments, second drive motor 434 includes an anti-backlash gearbox 436 for connecting with pulley system 428. Second drive motor 434 may be an AC-based motor or a DC-based motor.

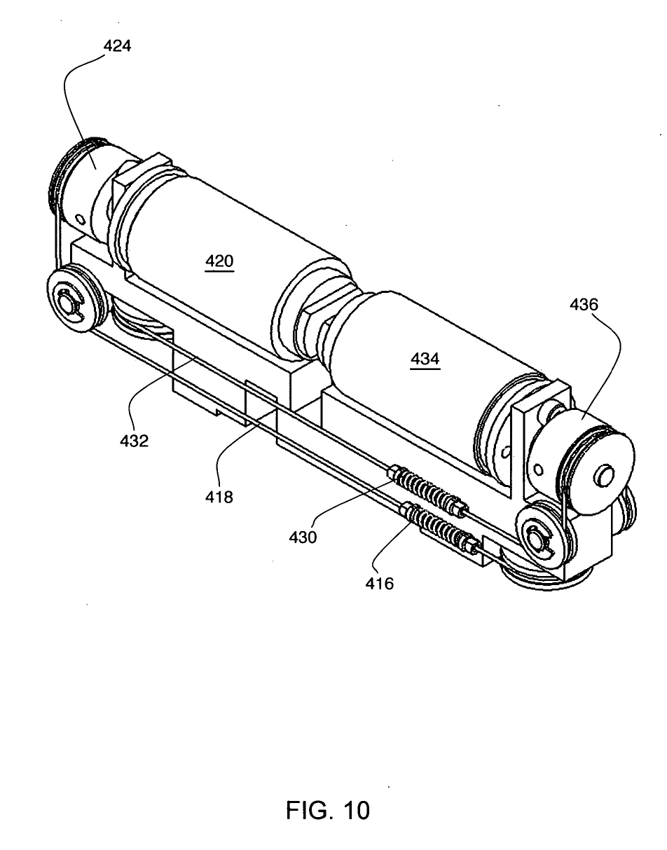

FIG. 10 depicts a detailed view of another portion of system 300 and includes first and second drive motors 420, 434 connected with first and second gearboxes 424, 436 which in turn connect with first and second pulley systems 414, 428. First and second pulley systems 414, 428 include first and second pulley lines 418, 432 having respective tension springs 416, 430.

FIG. 11 is a reverse perspective view of the FIG. 10 embodiment including a first and second lure 1100, 1102 each attached to first and second pulley lines 418, 432, respectively.

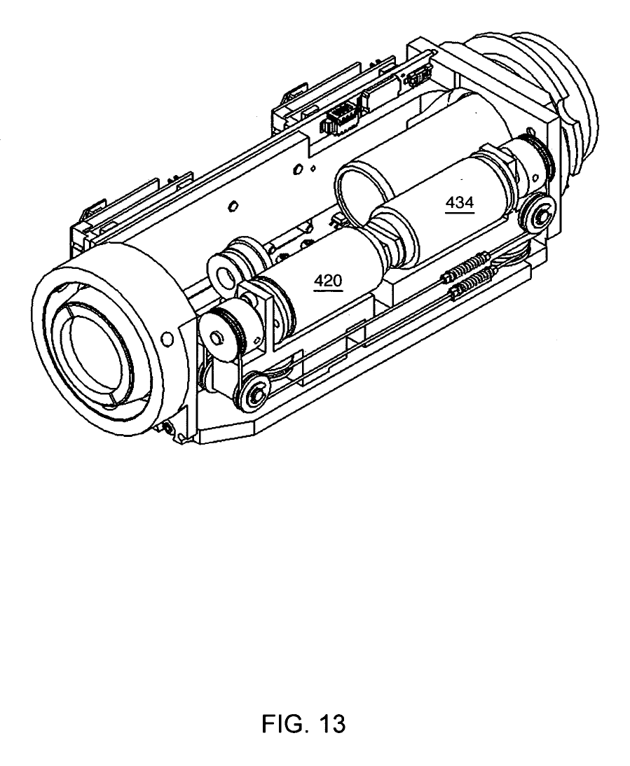

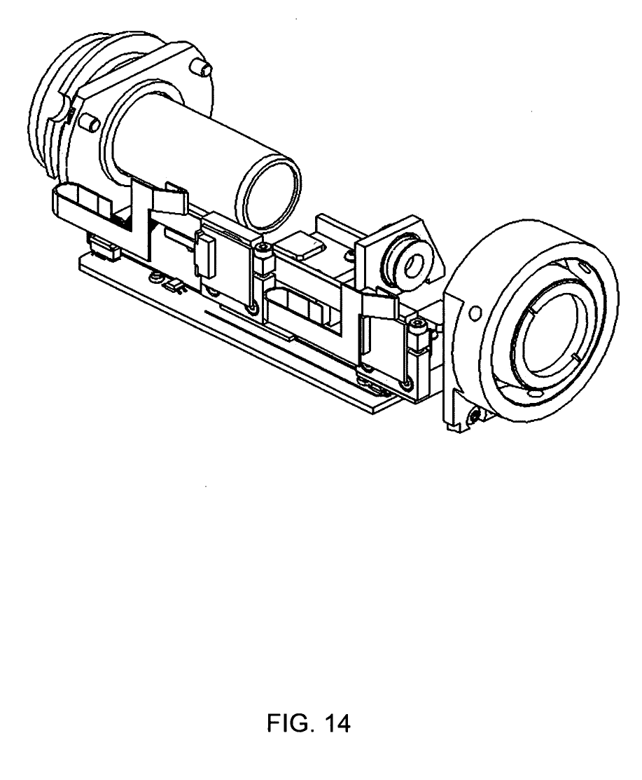

FIG. 13 is a perspective view of another embodiment of system 300. FIG. 14 is another perspective view of another embodiment of system 300 with portions of system 300 hidden, e.g., first and second drive motors 420, 434.

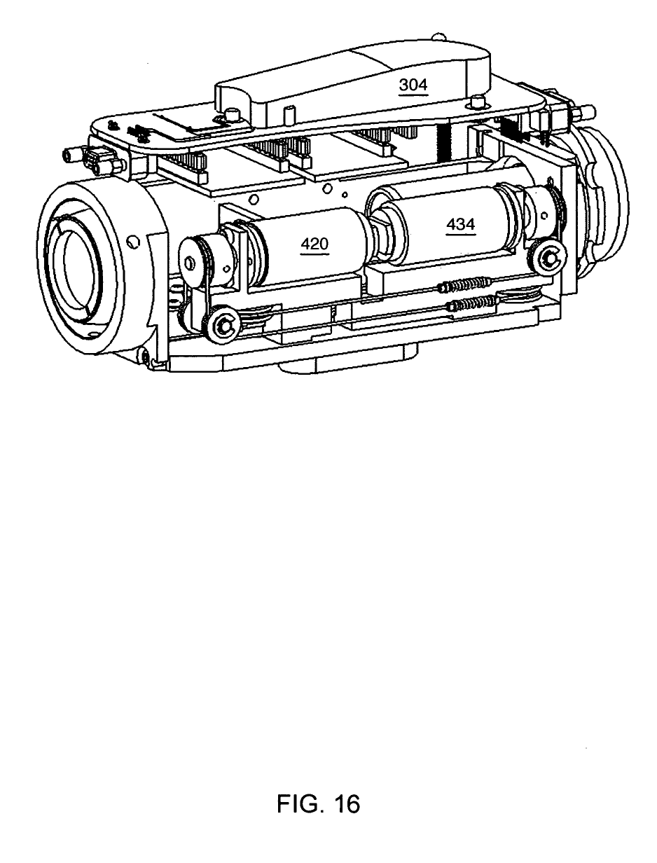

FIG. 16 is another perspective view of the FIG. 14 zoom system 300 embodiment. In particular, FIG. 16 includes control panel 304 above optical axis B of the fixed and movable lenses.

Returning to FIG. 4, control panel 304 connects with control system 422. Additionally, a communication port 426 connects with control system 422 in order to transfer control signals to system 300 via wired and/or wired connections from devices external to the zoom system. Communication port 426 may be a serial or parallel communication port, e.g., an RS-232, RS-422, USB, FIREWIRE (IEEE 1394), BLUETOOTH, or other communication mechanism. In some embodiments, zoom system 300 includes one or both of control panel 304 and communication port 426. In some embodiments, zoom system 300 may be controlled, i.e., receive appropriate control signals over communication port 426 via a computer system, e.g., a desktop, notebook, handheld, server, or other personal computer, a personal digital assistant, a dedicated controller, or other control devices. Further, in some embodiments, communication port 426 may include either a wired or wireless communication capability, e.g., a wired network such as Ethernet, or other wired networking methods, and a wireless network such as IEEE 802.11a/b/g, infrared, BLUETOOTH or other wireless networking methods.

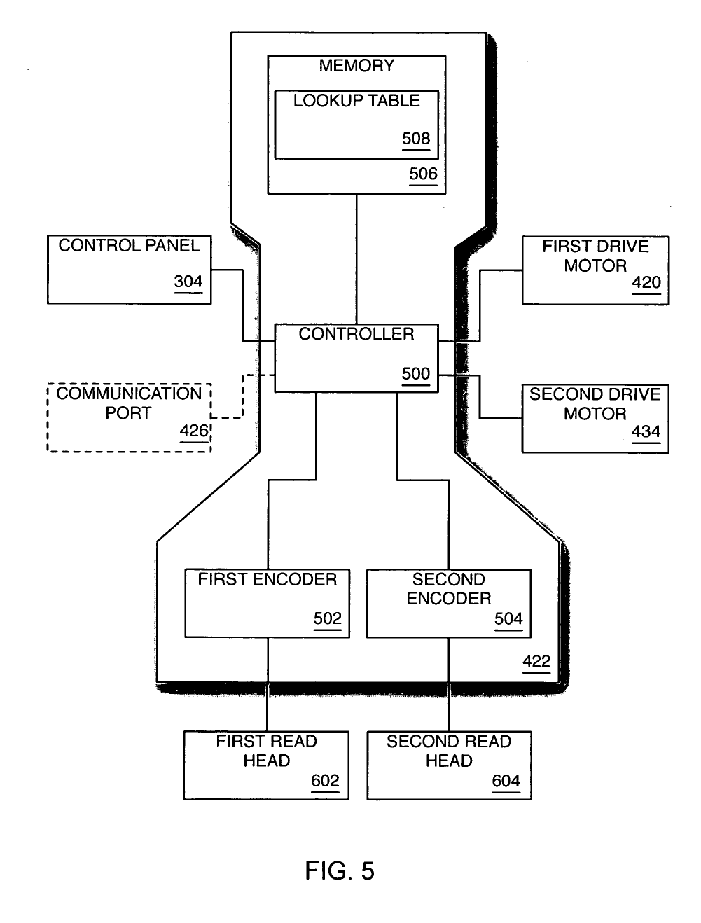

FIG. 5 depicts a high level block diagram of control system 422 connected with control panel 304, first and second drive motors 420, 434, and first and second read heads 602, 604. Control system 422 includes a controller 500, e.g., a processor, a logic device, or other control circuit, etc., connected with a first encoder 502, a second encoder 504, and a memory 506. In some embodiments, communication port 426 is optionally connected with control system 422 in order for control signals to be received for controlling operation of zoom system 300.

Controller 500 receives control signals from control panel 304 for controlling the operation of zoom system 300. Control signals include increase zoom (increase magnification level), decrease zoom (decrease magnification level), increase speed (increase the rate of change between magnification levels), and decrease speed (decrease the rate of change between magnification levels). Control system 422 receives additional control signals in other embodiments. In further embodiments, control system 422 receives control signals from communication port 426.

Receipt of an increase zoom signal or a decrease zoom signal from control panel 304 causes controller 500 to transmit a signal to first and second drive motors 420, 434, as described below, to cause the motors to move first and second movable lens carriages 404, 406 at a particular velocity until the controller receives signals from first and second read heads 602, 604 indicating the carriages have moved to a particular position along rail 408. Receipt of an increase speed signal or a decrease speed signal from control panel 304 causes controller 500 to modify the signal transmitted to first and second drive motors 420, 434 to cause the motors to move first and second movable lens carriages 404, 406 at a different velocity. In some embodiments, controller 500 transmits a pulse width modulated signal in the form of a low voltage, low current signal to a power amplifier (not shown) which converts the signal into a high voltage, high current signal to drive a particular motor.

In some embodiments, controller 500 may transmit a signal to first and second drive motors 420, 434 to cause the motors to move first and second movable lens carriages 404, 406 at a particular acceleration/deceleration rate.

First and second encoders 502, 504 receive signals from first and second read heads 602, 604, respectively. In some embodiments, the received signals convey information relating to the direction and distance of the motion of first and second movable lens carriages 404, 406. In a further specific non-limiting embodiment, the signal is a quadrature pulse train where the number of pulses indicates the distance and the phase position of one pulse relative to another indicates the direction. In some further embodiments, the received signal indicates the direction and velocity and/or acceleration of movable lens carriages 404, 406.

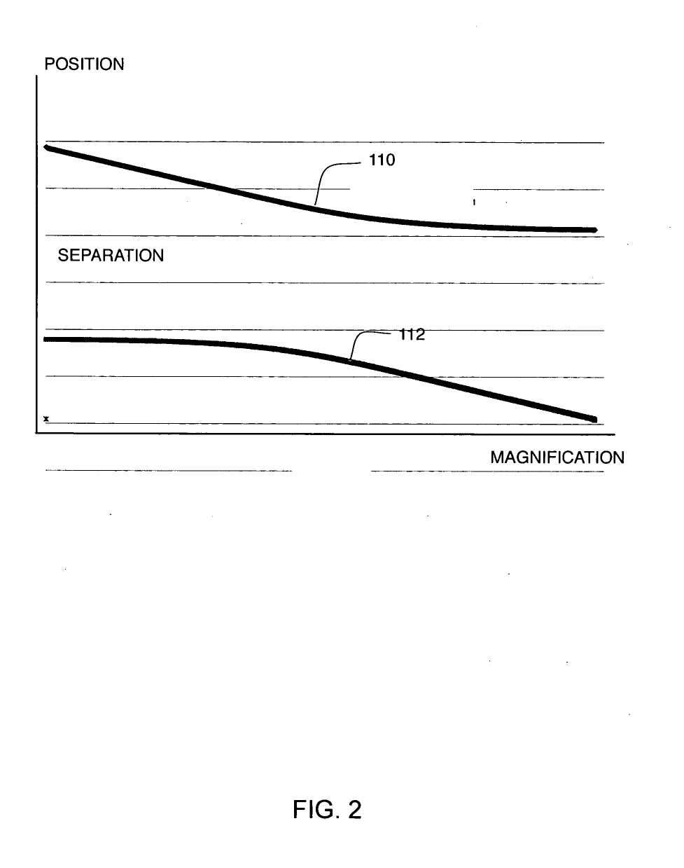

Controller 500 refers to (accesses and/or requests information from) a lookup table 508 stored in memory 506 to determine the particular position along rail 408 to which first and second drive motors 420, 434 move first and second movable lens carriages 404, 406. Lookup table stores position information of carriages 404, 406 for a given magnification level. In this manner, a non-linear relationship, e.g., as graphically depicted in FIG. 2, between the carriages 404, 406 position may be specified for access by controller 500.

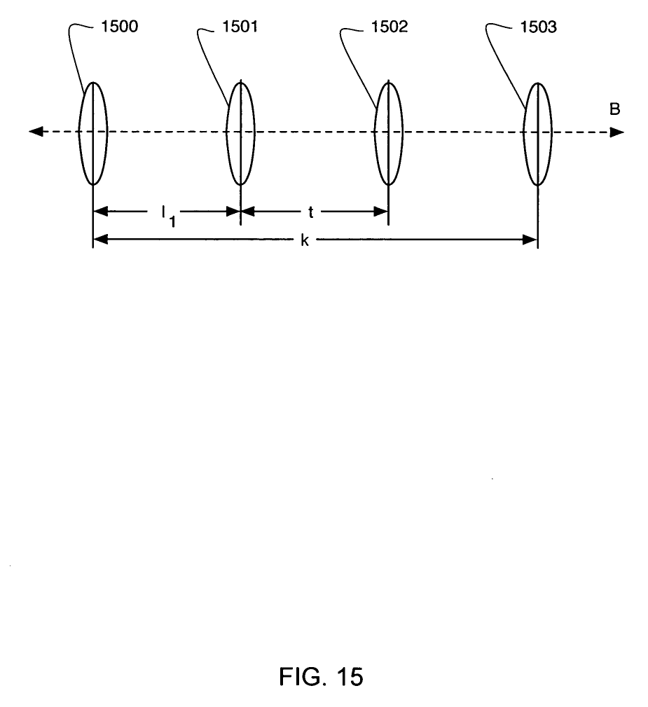

In some embodiments, controller 500 calculates the position information of carriages 404, 406 for a given magnification level instead of using lookup table 508. In a particular embodiment of zoom system 300 having two fixed lens elements and two movable lens carriages each including lenses as described above, controller 500 calculates the destination position of carriages 404, 406 based on the following equations:

$$\begin{matrix}a = \frac{{( 1 - m )}^{2}}{m} or ma = {( 1 - m )}^{2} & ( eq . 1 ) \\ t = 1 / 2 [ k \pm \sqrt{{k}^{2} - 4 {f}_{a}^{′} {f}_{b}^{′} a - 4 k ( {f}_{a}^{′} + {f}_{b}^{′} )} ] & ( eq . 2 ) \\ {l}_{1} = \frac{- {f}_{a}^{′} [ k - t ( 1 - m ) ]}{{f}_{a}^{′} ( 1 - m ) + mt} & ( eq . 3 )\end{matrix}$$

where m is the desired magnification, I₁ is the distance between a first fixed lens and the nearest movable lens, t is the distance between the first and second movable lenses, k is the distance between the first and second fixed lenses, and f′ₐ and f′_{b} are the focal length of the first and second movable lenses, respectively. FIG. 15 diagrammatically depicts the above-described embodiment including first and second fixed lenses 1500, 1501, respectively, and first and second movable lenses 1502, 1053, respectively.

In some further embodiments, zoom system 300 need not include fixed lens elements 306, 400. According to such embodiments, one and/or the other of fixed lens elements may be replaced with an airspace and/or a media.

In either case, controller 500 determines the desired position of carriages 404, 406 and transmits a signal to each of motors 420, 434 to move the carriages to the desired position. Read heads 602, 604 detect and transmit a signal representing the motion of carriages 404, 406 along rail 408 to controller 500 which terminates the signal to each of motors 420, 434 after the carriages reach the desired position. In some embodiments, controller 500 may transmit a signal to one or both of motors 420, 434 to cause the motor to move one or both of carriages 404, 406 an additional amount, either forward or backward, to account for the motion of a carriage over-or undershooting a desired position. Further, in some embodiments, controller 500 may move one or both of carriages 404, 406 sequentially over time (one after the other) or at the same time.

In some embodiments, read heads 602, 604 detect and transmit a signal including a direction component and a distance component. In some further embodiments, read heads 602, 604 detect and transmit a signal including a velocity component and/or an acceleration component.

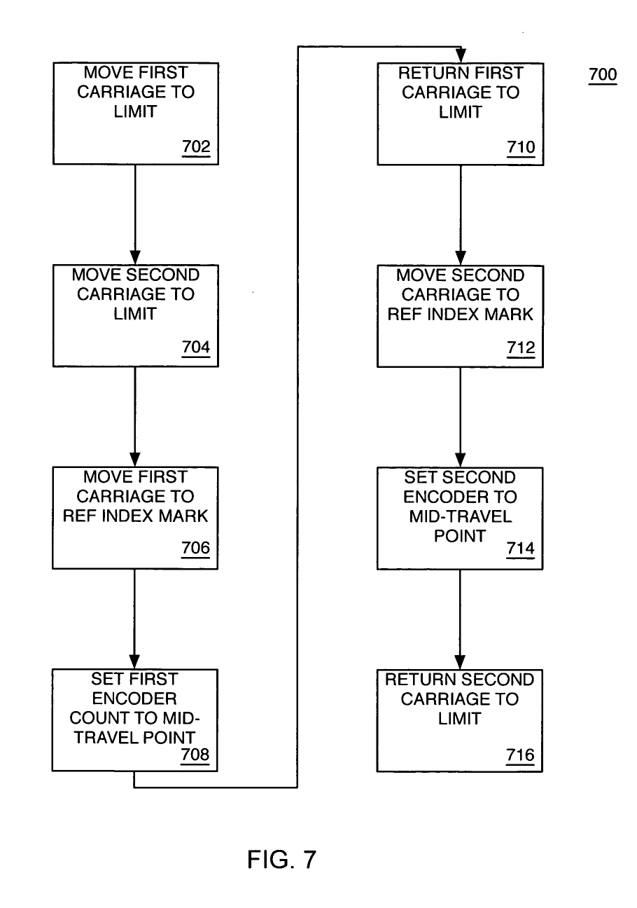

FIG. 7 depicts a process flow diagram of a portion of operation of control system 422 during a calibration process 700. Control system 422 may perform calibration process 700 after power is applied to zoom system 300, or at a user-specified or system-specified time during use.

The process flow begins at step 702 and control system 422, as described above, causes first movable lens carriage 404 to move to a first carriage limit position, i.e., toward the end of rail 408 distal from second movable lens carriage 406. The flow proceeds to step 704 and control system 422 causes second movable lens carriage 406 to move to a second carriage limit position, i.e., toward the end of rail 408 distal from first movable lens carriage 404. The flow proceeds to step 706.

At step 706, control system 422 causes first movable lens carriage 404 to move to a reference index mark on tape 602. Reference index mark is specified as being located halfway between the first carriage limit position and the second carriage limit position. The flow proceeds to step 708 and first encoder 502 stores an indicator of the position of first carriage 404. The stored indicator may be a count based on the signal received from first read head 602 during movement of first carriage 404. The flow proceeds to step 710 and control system 422 causes first carriage 404 to return to the first limit position.

The flow proceeds to step 712 and control system 422 causes second movable lens carriage 406 to move to the reference index mark on tape 602. The flow proceeds to step 714 and second encoder 504 stores an indicator of the position of second carriage 406. The flow proceeds to step 716 and control system 422 causes second carriage 406 to return to the second limit position.

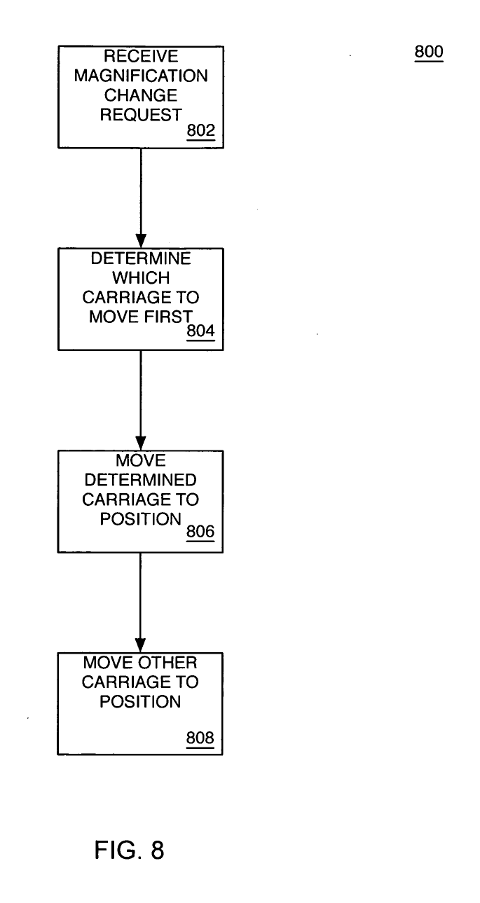

FIG. 8 depicts a process flow diagram of a portion of operation of control system 422 during a magnification change process 800. The process flow begins at step 802 and control system 422 receives a magnification level change request, i.e., an increase zoom signal or a decrease zoom signal. Responsive to the received request, control system 422 determines, e.g., based on reference to lookup table 508, the desired positions of the carriages 404, 406 to achieve the desired magnification level. The flow proceeds to step 804.

At step 804, control system 422 determines which movable lens carriage of carriages 404, 406 to move first based on the carriages' current positions along rail 408 and the desired positions of the carriages. The carriage determined to be the first to move is referred to as the first mover. Control system 422 performs this step in order to avoid collisions between carriages 404, 406 as they are coaxially located along rail 408. The flow proceeds to step 806.

At step 806, control system 422 causes the above-determined “first mover” carriage to move to the desired position along rail 408 with reference to tape 602. The flow proceeds to step 808 and control system 422 causes the “second mover” carriage to move to the desired position along rail 408 to achieve the requested magnification level.

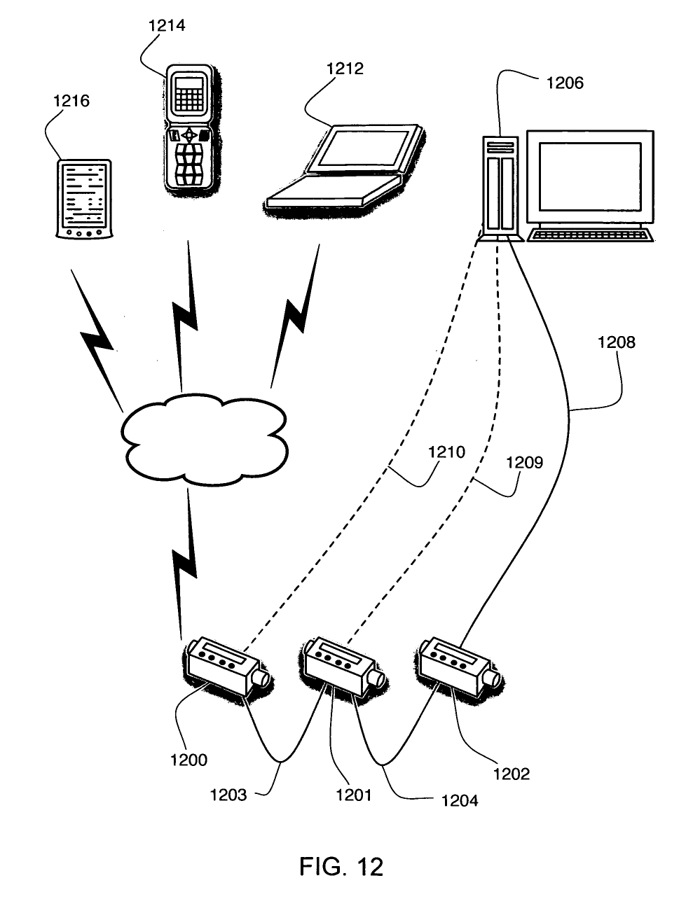

FIG. 12 depicts a high level diagram of three networked zoom systems 1200, 1201, 1202 similar to zoom system 300 described above. Zoom systems 1200-1202 are connected via communication port 426 using one or more of a communication connection 1203, 1204. Communication connection 1203, 1204 may be a serial or parallel connection and in some non-limiting embodiments may be a wired and/or wired connection. Communication connection 1203, 1204 communicates signals between zoom systems 1200-1202, e.g., using a protocol such as FIREWIRE.

A computer system 1206, e.g., a desktop, server, or other computer system, connects with at least one zoom system 1202 via wired connection 1208 to communicate control signals. Wired connection 1208 may be a serial and/or parallel connection to communication port 426 of zoom system 1202. Computer system 1206 may optionally be connected via wired connection 1209, 1210 (dashed line) with zoom systems 1200, 1202. In some embodiments, if a connection exists between zoom systems 1200-1202, computer system 1206 need only connect to one of the three zoom systems.

Other devices may be used to connect to and provide control signals to zoom systems 1200-1202, e.g., a laptop computer 1212, a wireless device such as a phone 1214, and another wireless device such as a personal digital assistant 1216. Each of devices 1212, 1214, 1216 connect wirelessly to communication port 426 of zoom system 1200 to provide control signals. Zoom system 1200 may forward control signals to zoom systems 1201, 1202.

As described above, although control system 422 determines the positions of carriages 404, 406 with reference to lookup table 508, in other embodiments, the control system may calculate the positions of the carriages to achieve the desired magnification level.

Although FIG. 3 depicts housing 302 as generally right, rectangular parallelepiped-shaped, the housing shape may differ in other embodiments or be dispensed with partially or in its entirety.

Further, although FIG. 3 depicts control panel 304 located on an upper surface of housing 302, in other embodiments, control panel 304 may be located on another portion of housing 302 or separate from the housing. In a further embodiment, control panel 304 may be replaced by a wired and/or wireless connection providing the described control signals to zoom system 300, e.g., from a computer or a network connection.

Frame 402 may be a metallic material, e.g., aluminum, etc., a plastic material, or other material to which components of system 300 may be attached. As depicted in FIG. 4, frame 402 is a solid, generally rectangular shape; however, frame 402 may be different shapes without departing from the scope and spirit of the disclosed embodiments. Further, frame 402 may be individual connected components.

Based on the above-described system 300, an example embodiment tested by an inventor has shown repeatability levels for accurately moving a movable lens carriage to a predetermined lens carriage position within +/−2 μm at a 0.1% magnification repeat.

In some embodiments, one or the other or both of pulley systems 414, 428 may be replaced by a direct drive mechanism such as a screw drive or other mechanism for directly connecting the first and second drive motors 420, 434 with respective first and second movable lens carriages 404, 406.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. An optical zoom system for positioning a movable lens carriage, comprising:
a drive motor;
a movable lens carriage operatively connected with the drive motor and movable by the drive motor, the movable lens carriage comprising:
a read head for generating a signal indicative of a position of the movable lens carriage; and
a control system operatively connected with the movable lens carriage and adapted to receive the read head generated signal, and operatively connected with the drive motor and adapted to generate a signal to cause the drive motor to move the movable lens carriage and adapted to generate a signal to cause the drive motor to at least one of:
(a) stop moving the movable lens carriage based on the received read head generated signal and
(b) move the movable lens carriage based on the received read head generated signal.

2. An optical zoom system for positioning movable lens carriages, comprising:
a linear extending rail;
a first movable lens carriage operatively coupled with and movable along a portion of the rail, the first movable lens carriage comprising:
a first read head positioned to detect and generate a first read head signal indicative of motion of the first movable lens carriage along a portion of the rail;
a second movable lens carriage operatively coupled with and movable along a portion of the rail, the second movable lens carriage axially aligned with the first movable lens carriage and comprising:
a second read head positioned to detect and generate a second read head signal indicative of motion of the second movable lens carriage along a portion of the rail;
a first drive motor operatively coupled with the first movable lens carriage and arranged to move the first movable lens carriage along a portion of the rail responsive to a first control signal;
a second drive motor operatively coupled with the second movable lens carriage and arranged to move the second movable lens carriage along a portion of the rail responsive to a second control signal; and
a control system operatively connected with the first and second movable lens carriages and the first and second drive motors, the control system arranged to generate at least one of a first control signal and a second control signal responsive to receipt of a magnification change signal.

3. An optical zoom system according to claim 2, further comprising:
a pair of fixed lenses axially aligned parallel with the rail;
wherein the first movable lens carriage and the second movable lens carriage positioned between the pair of fixed lenses and positioned such that lenses attached to the first and second movable lens carriages are axially aligned with the pair of fixed lenses.

4. An optical zoom system according to claim 2, wherein the first and second drive motors are independently operable.

5. An optical zoom system according to claim 2, wherein the first and second read heads are optical read heads.

6. An optical zoom system according to claim 2, further comprising:
a first pulley system connected between the first drive motor and the first movable lens carriage;
a second pulley system connected between the second drive motor and the second movable lens carriage.

7. An optical zoom system according to claim 6, the first and second pulley systems each including a respective tension spring.

8. An optical zoom system according to claim 2, wherein the control system generates at least one of a first control signal and a second control signal based on at least one of the first read head signal and the second read head signal.

9. An optical zoom system according to claim 2, further comprising a tape scale extending linearly and parallel with the rail, wherein the first and second read heads are positioned to detect and generate the respective first and second read head signals based on the tape scale.

10. An optical zoom system according to claim 9, wherein the tape scale is positioned adjacent the rail and includes spaced indicators detectable by the first and second read heads.

11. An optical zoom system according to claim 2, wherein the control system comprises:
a memory arranged to store a lookup table of values specifying a position of the first and second movable lens carriages in order to obtain a particular magnification level and
wherein the control system generates at least one of the first and second control signals based on a lookup table value.

12. An optical zoom system according to claim 2, further comprising:
one or more additional movable lens carriages operatively coupled with and movable along a portion of the rail, each of the one or more additional movable lens carriage axially aligned with the first movable lens carriage and comprising:
one or more read heads positioned to detect and generate one or more read head signals indicative of motion of each of the respective one or more additional movable lens carriages along a portion of the rail;
one or more additional drive motors each operatively coupled with one of the one or more additional movable lens carriages and arranged to move the respective one or more additional movable lens carriages along a portion of the rail responsive to a respective control signal;
wherein the control system is operatively coupled with each of the one or more additional movable lens carriages and each of the one or more additional drive motors, the control system arranged to generate a respective control signal responsive to receipt of a magnification change signal.

13. An optical zoom system for positioning movable lens carriages, comprising:
a linear extending rail;
a pair of fixed lenses axially aligned parallel with the rail;
a first movable lens carriage operatively coupled with and movable along a portion of the rail, the first movable lens carriage comprising:
a first read head positioned to detect and generate a first read head signal indicative of motion of the first movable lens carriage along a portion of the rail; wherein the first read head is an optical read head;
a second movable lens carriage operatively coupled with and movable along a portion of the rail, the second movable lens carriage axially aligned with the first movable lens carriage and comprising:
a second read head positioned to detect and generate a second read head signal indicative of motion of the second movable lens carriage along a portion of the rail; wherein the second read head is an optical read head;
a first drive motor operatively coupled with the first movable lens carriage and arranged to move the first movable lens carriage along a portion of the rail responsive to a first control signal;
a second drive motor operatively coupled with the second movable lens carriage and arranged to move the second movable lens carriage along a portion of the rail responsive to a second control signal, wherein the second drive motor is independently operable from the first drive motor;
a first pulley system connected between the first drive motor and the first movable lens carriage;
a second pulley system connected between the second drive motor and the second movable lens carriage; and
a control system operatively connected with the first and second movable lens carriages and the first and second drive motors, the control system arranged to generate at least one of a first control signal and a second control signal responsive to receipt of a magnification change signal;
wherein the first movable lens carriage and the second movable lens carriage positioned between the pair of fixed lenses and positioned such that lenses attached to the first and second movable lens carriages are axially aligned with the pair of fixed lenses.

14. A method of modifying a magnification level of an image provided by an optical zoom system, the method comprising:
(A) generating, by a control system, a first control signal to cause a first drive motor to move a first movable lens carriage to a predetermined position responsive to receipt of a magnification change signal;
(B) generating by the first movable lens carriage a first read head signal based on detection by a first read head of an indicator on a tape scale adjacent the first read head; and
(C) generating, by the control system, a second control signal to cause the first drive motor to stop moving the first movable lens carriage at the predetermined position responsive to receipt of the first read head signal.

15. A method according to claim 14, wherein step A includes determining, by the control system, the predetermined position based on a current position of the first movable lens carriage and the magnification change signal.

16. A method according to claim 15, wherein the determining step is performed with reference to one or more lookup table values stored in a memory.

17. A method according to claim 15, wherein the control system calculates the predetermined position.

18. A method according to claim 14, wherein the first read head signal includes a direction component and a distance component.

19. A method according to claim 14, wherein step A further comprises:
determining which of the one or more movable lens carriages to move first based on the current position of each of the one or more movable lens carriages and the predetermined position for each of the one or more movable lens carriages.

20. A method according to claim 14, further comprising:
(D) generating, by the control system, a third control signal to cause a second drive motor to move a second movable lens carriage to an other predetermined position responsive to receipt of the magnification change signal;
(E) generating by the second movable lens carriage a second read head signal based on detection by a second read head of an indicator on the tape scale adjacent the second read head; and
(F) generating, by the control system, a fourth control signal to cause the second drive motor to stop moving the second movable lens carriage at the other predetermined position responsive to receipt of the second read head signal.

21. A memory or a computer-readable medium storing instructions which, when executed by a processor, cause the processor to perform the method of claim 14.

22. A method of modifying a magnification level of an image provided by an optical zoom system, the method comprising:
(A) generating, by a control system, a first control signal to cause a first drive motor to move a first movable lens carriage to a predetermined position responsive to receipt of a magnification change signal, including determining, by the control system, the predetermined position based on a current position of the first movable lens carriage and the magnification change signal;
(B) generating by the first movable lens carriage a first read head signal based on detection by a first read head of an indicator on a tape scale adjacent the first read head, wherein the first read head signal includes a direction component and a distance component;
(C) generating, by the control system, a second control signal to cause the first drive motor to stop moving the first movable lens carriage at the predetermined position responsive to receipt of the first read head signal;
(D) generating, by the control system, a third control signal to cause a second drive motor to move a second movable lens carriage to an other predetermined position responsive to receipt of the magnification change signal;
(E) generating, by the second movable lens carriage, a second read head signal based on detection by a second read head of an indicator on the tape scale adjacent the second read head; and
(F) generating, by the control system, a fourth control signal to cause the second drive motor to stop moving the second movable lens carriage at the other predetermined position responsive to receipt of the second read head signal;
determining, by the control system, the predetermined first position based on a current position of the first movable lens carriage and the magnification change signal; wherein the determining step is performed with reference to one or more lookup table values stored in a memory; and
wherein step A further comprises: determining which of the one or more movable lens carriages to move first based on the current position of each of the one or more movable lens carriages and the predetermined position for each of the one or more movable lens carriages.

23. A method of positioning a movable lens carriage of an optical zoom system, the method comprising:
generating a control signal to move a movable lens carriage based on a first position of the movable lens carriage and a destination position of the movable lens carriage;
generating a modified version of the control signal based on a detected position of the movable lens carriage and the destination position.

24. A method according to claim 23, wherein the detected position of the movable lens carriage is detected by the movable lens carriage.

25. A method according to claim 23, wherein the control signal specifies at least one of: a direction in which to move the movable lens carriage, a distance to move the movable lens carriage, a velocity at which to move the movable lens carriage, and an acceleration rate to move the movable lens carriage.
